(19) United States
(12) Patent Application Publication
(10) Pub. No.: US 2010/0146608 A1
(43) Pub. Date: Jun. 10, 2010

(54) Multi-Level Secure Collaborative Computing Environment

(75) Inventors: Robert B. Batie, Lutz, FL (US); Luisito D. Espiritu, Clearwater, FL (US); Sil N. Mudsi, Olney, MD (US); Maria A.F. Andrews, Clearwater, FL (US); Daniel Teijido, Tampa, FL (US); Sylvia A. Traxler, Seminole, FL (US); Stephan Gonzalez, Clearwater, FL (US); Alen Cruz, Tampa, FL (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/419,860

(22) Filed: Apr. 7, 2009

Related U.S. Application Data
(60) Provisional application No. 61/120,430, filed on Dec. 6, 2008.

(51) Int. Cl. H04L 9/32; G06F 21/00

(52) U.S. Cl. 726/7; 713/172

(57) ABSTRACT

In some embodiments, a collaborative computing environment includes a federated identity manager coupled to a multi-level secure computing network and a client having a biometric reading device. The multi-level secure computing network includes multiple data repositories that store information according to a ranked classification system comprising multiple security levels. The federated identity manager has a storage device that is operable store a plurality of identity tokens each associated with a corresponding one of a plurality of users. In operation, the federated identity manager receives, from the biometric reading device, a biometric signature associated with a particular one of the users, initiates a login session with the client according to the received biometric signature associated with the particular user, and restricts access to the information stored in the data repositories according to one or more security levels associated with the particular user as specified by the identity token associated with the particular user.

### RELATED APPLICATIONS

This application claims the benefit under 35 U.S.C. section 119(e) of the priority of U.S. Provisional Application No. 61/120,430, filed Dec. 6, 2008, entitled “Multi-Level Secure Collaborative Computing Environment.”

### TECHNICAL FIELD OF THE DISCLOSURE

This disclosure generally relates to distributed computing system, and more particularly, to a multi-level secure collaborative computing environment.

### BACKGROUND

Distributed computing systems typically incorporate numerous individual computers that communicate with one another through a network. A federated computing system is a type of distributed computing system in which information is dispersed at varying locations within the network and accessible through information portals. In many cases, federated computing systems are configured to operate in a client/server model in which their execution is shared between a server and a client. Services of distributed computing systems may incorporate various levels of security to protect an organization's information from illicit use or access.

Multi-level security is an aspect of computing system design in which differing processes process information at differing security levels. A multi-level security system usually incorporates a multi-tiered security scheme in which users have access to information managed by the enterprise based upon one or more authorization levels associated with each user.

### SUMMARY

In some embodiments, a collaborative computing environment includes a federated identity manager coupled to a multi-level secure computing network and a client having a biometric reading device. The multi-level secure computing network includes multiple data repositories that store information according to a ranked classification system comprising multiple security levels. The federated identity manager has a storage device that is operable store a plurality of identity tokens each associated with a corresponding one of a plurality of users. In operation, the federated identity manager receives, from the biometric reading device, a biometric signature associated with a particular one of the users, initiates a login session with the client according to the received biometric signature associated with the particular user, and restricts access to the information stored in the data repositories according to one or more security levels associated with the particular user as specified by the identity token associated with the particular user.

Certain embodiments of the present disclosure may provide one or more technical advantages. For example, certain embodiments of the collaborative computing environment may provide enhanced security for compartmented computing systems operating in a virtual world environment. Virtual world environments may provide relatively more efficient use due to their ergonomic look-and-feel. Conventional implementations of virtual world engines that drive virtual world environments, however, may not natively include adequate security measures to be used with compartmented computing systems that are administered with a relatively high degree of security. The collaborative computing system according to certain embodiments of the present disclosure may provide a solution to this problem by implementing biometric reading devices with each client that accesses information to enhance security associated with each user.

Certain embodiments of the present disclosure may include some, none, or all of these advantages. One or more other technical advantages may be readily apparent to those skilled in the art from the figures, descriptions, and claims included herein.

### BRIEF DESCRIPTION OF THE DRAWINGS

To provide a more complete understanding of the present disclosure and the features and advantages thereof, reference is made to the following description taken in conjunction with the accompanying drawings, in which:

FIG. 1 illustrates an example multi-level secure collaborative computing environment according to certain embodiments of the present disclosure;

FIG. 2 illustrates an example virtual world environment that may be generated by the multi-level secure collaborative computing environment of FIG. 1 according to certain embodiments of the present disclosure; and

FIG. 3 illustrates an example series of actions that may be performed by the multi-level secure collaborative computing environment of FIG. 1 according to certain embodiments of the present disclosure.

### DESCRIPTION OF EXAMPLE EMBODIMENTS

As described previously, a federated computing system typically includes multiple individual computing systems that each stores a portion of information that may be accessible to numerous users. In many cases, information stored in federated computing systems may have differing levels of sensitivity. That is, some information may be relatively more private than other information. To protect information in computing systems, such as federated computing systems, a multi-level security (MLS) scheme may be used. For example, a government or other suitable entity may use a multi-level security scheme that includes secret, top secret (TS), and various types of top secret/sensitive compartmented information (TS/SCI) security levels.

To accommodate the relatively large amounts of information and computing processes that use information, virtual world environments have been developed. A virtual world environment is a simulated real-world environment that may include various processes and/or access points to access information at other locations. Originally, virtual world environments often included imaginary characters participating in fictional events and activities. Due to their relatively desirable ergonomics, now these virtual world environments are used frequently to manage business applications and information used in these business applications. Although conventional virtual world environments generally provide certain ergonomic benefits, they generally do not provide sufficient security for use with federated computing systems that share information in a compartmented fashion, such as those using a multi-level security scheme.

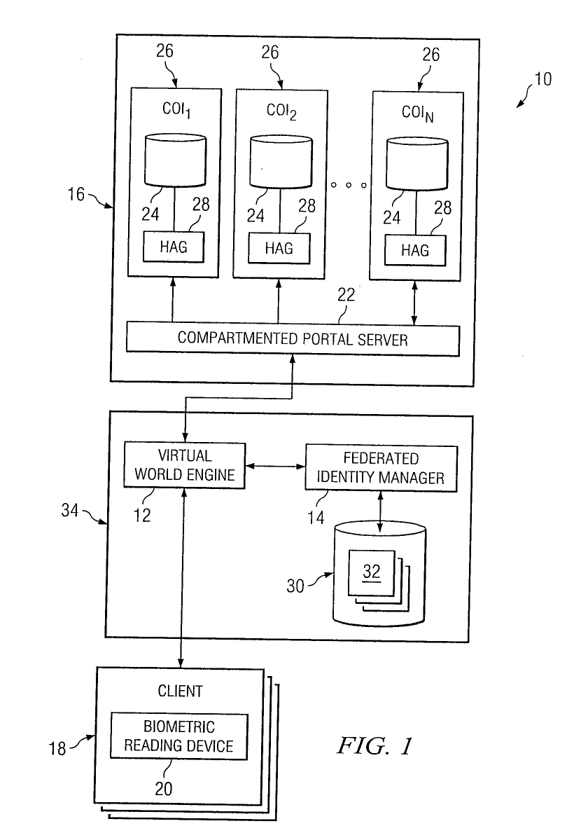

FIG. 1 illustrates an example multi-level secure collaborative computing environment 10 according to certain embodiments of the present disclosure. Collaborative computing environment 10 may include a virtual world engine 12 coupled to federated identity manager 14, a compartmented computing system 16, and one or more clients 18 that each have a biometric reading device 20. Although a particular embodiment of collaborative computing environment 10 is illustrated and primarily described, the present invention contemplates collaborative computing environment 10 including any suitable components according to particular needs.

Compartmented computing system 16 may include a compartmented portal server 22 that provides multi-level security access to multiple data repositories 24 managed by differing communities of interest 26 through high assurance guards 28. Federated identity manager 14 may be coupled to a storage device 30 that stores multiple avatars 32 corresponding to a plurality of users of compartmented computing system 16 (e.g., users of clients 18).

Data repositories 24 and storage device 30 may each include any memory or database module and may take the form of volatile or non-volatile memory, including, without limitation, magnetic media, optical media, random access memory (RAM), read-only memory (ROM), removable media, or any other suitable local or remote memory component. In some embodiments, one or more of data repositories 24 and storage device 30 includes one or more SQL servers.

As will be described in greater detail below, virtual world engine 12 may provide a virtual world environment to provide access to information stored in data repositories 24 with a multi-level security scheme that is assured through the use of biometric signatures obtained from biometric reading devices 20 using federated identity manager 14. Certain embodiments of a compartmented computing system 16 incorporating the use of biometric reading devices 20 may provide relatively robust protection from illicit access and/or manipulation of information used by compartmented computing system 16. Virtual world engine 12 may manage actions of users (e.g., of clients 18) within the virtual world environment through the use of identity tokens commonly referred to as “avatars” (i.e., shown as avatars 32 in FIG. 1).

Although conventional implementations of virtual world engines 12 may provide security from illicit use when used in a fictional setting, they may provide insufficient security when implemented in business applications such as in compartmented computing system 16 using a multi-level security scheme. Thus, compartmented computing systems 16 configured with a virtual world engine 12 that accesses biometric reading devices 20 to establish the identity of users may provide improved security for use with business computing systems implementing a multi-level security scheme in some embodiments.

Compartmented computing system 16, which may be referred to as a multi-level secure computing network, may be a type of federated computing network in which multiple communities of interest 26 share information among one another using a multi-level security scheme. Communities of interest 26 may include any organization or domain that collaborates with others over a common network infrastructure. One particular example may include the United States Department of Defense, its related vendors, and/or other organizations. When linked together through a common portal server 22, users from the various participating communities of interest 26 may share their information with one another in a relatively efficient manner.

The United States Department of Defense maintains a multi-tiered, ranked security scheme for managing information. This information may be classified in multiple ascending levels of security including confidential, secret, or top secret (TS) security levels. In addition to these security levels, some classified information is sufficiently sensitive such that additional security levels are applied to the various classifications. These additional security levels may include, for example, sensitive compartmented information (SCI) or special access programs (SAP). Although these particular example security levels are primarily described, the present disclosure contemplates any suitable security levels being used in environment 10, according to particular needs.

A security clearance may be granted to users of collaborative computing environment 10 for a particular clearance level. For example, a security system may establish a ranked classification system (i.e., from least sensitive to most sensitive) of confidential, secret, top secret, and sensitive compartmented information. These security levels may also incorporate sensitive compartmented information commonly referred to as caveats on a “need to know” basis. Thus a user with access to one compartment of information may not necessarily have a “need-to know” and hence may not have access to another compartment of information. Each compartment may include its own additional clearance process. Certain government departments may also establish special access programs when the risk of loss associated with certain information warrants its use.

Information stored in data repositories 24 may be stored in a database, a file system, or other suitable format for the organization of information that is accessible by client 18. High assurance guard 28 may restrict access to information stored in data repositories 24 according to a security level associated with a request for that information. High assurance guard 28 may validate requests for information using one or more security levels associated with each request.

Virtual world engine 12 may generate a virtual world environment that may provide a relatively ergonomic approach to accessing information from compartmented computing system 16. Any suitable type of virtual world engine 12 may be used. In some embodiments, virtual world engine 12 is implemented on a PROJECT WONDERLAND platform that is executed with PROJECT DARKSTAR engine available through SUN MICROSYSTEMS, located in Santa Clara, Calif. The PROJECT WONDERLAND platform and PROJECT WONDERLAND engine have native client/server architecture and are implemented with the JAVA programming language. The PROJECT WONDERLAND platform provides a structure from which various elements of compartmented computing system 16 may be virtually modeled in a virtual world environment.

Virtual world engine 12 maintains an avatar 32 for each user. Each avatar 32 may provide various types of information about its associated user and may be accessed when its associated user initiates a login session. Each avatar 32 may created when a user account is generated and may remain persistent throughout the existence of the user account. In some embodiments, avatars 32 each include one or more instances of biometric signatures that are unique to the user associated with the avatar 32. For example, avatars 32 may include biometric characteristics of users, such as their eye/retina color, fingerprint pattern, palm pattern, and/or facial image. Additionally or alternatively, avatars 32 may include user profile information of users, such as their date of birth, mother's maiden name, favorite color, or other obscure information that federated identity manager 14 may use to uniquely verify that the proper user is attempting to initiate a login session using a particular avatar 32.

The functionality of environment 10 may be provided using any suitable combination of hardware firmware and software.

Client 18 may include one or more computer systems at one or more locations. Client 18 may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media to both receive input from and provide output to a user of client 18. Client 18 may include a personal computer, workstation, network computer, kiosk, wireless data port, personal data assistant (PDA), Smart Phone, one or more processors within these or other devices, or any other suitable processing device.

Client 18 may include one or more processing modules and one or more memory modules. The one or more processing modules may include one or more microprocessors, controllers, or any other suitable computing devices or resources. The one or more processing modules may work, either alone or with other components of environment 10, to provide the functionality of environment 10 described herein. The one or more memory modules may take the form of volatile or non-volatile memory including, without limitation, magnetic media, optical media, RAM, ROM, removable media, or any other suitable memory component.

Virtual world engine 12 and federated identity manager 14 may be implemented on any suitable computing system 34. Computing system 34 may include one or more computers at one or more locations. Computing system 34 may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media to both receive input from and provide output to a user of computing system 34. Computing system 34 may include a personal computer, workstation, network computer, kiosk, wireless data port, PDA, Smart Phone, one or more processors within these or other devices, or any other suitable processing device. Computing system 34 may include any suitable combination of hardware, firmware, and software capable of executing instructions for implementing virtual world engine 12 and federated identity manager 14 according to the teachings of the present disclosure.

Computing system 34 may include one or more processing modules and one or more memory modules. The one or more processing modules may include one or more microprocessors, controllers, or any other suitable computing devices or resources. The one or more processing modules may work, either alone or with other components of environment 10, to provide the functionality of environment 10 described herein. The one or more memory modules may take the form of volatile or non-volatile memory including, without limitation, magnetic media, optical media, RAM, ROM, removable media, or any other suitable memory component.

Compartmented computing system 16 may include one or more computer systems at one or more locations. The one or more computer systems may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media to both receive input from and provide output to a user of compartmented computing system 16. Compartmented computing system 16 may include a personal computer, workstation, network computer, kiosk, wireless data port, PDA, Smart Phone, one or more processors within these or other devices, or any other suitable processing device.

Compartmented computing system 16 may include one or more processing modules and one or more memory modules. The one or more processing modules may include one or more microprocessors, controllers, or any other suitable computing devices or resources. The one or more processing modules may work, either alone or with other components of environment 10, to provide the functionality of environment 10 described herein. The one or more memory modules may take the form of volatile or non-volatile memory including, without limitation, magnetic media, optical media, RAM, ROM, removable media, or any other suitable memory component.

The one or more computer systems of environment 10 may be coupled together by one or more networks. The one or more networks may facilitate wireless or wireline communication. The one or more networks may communicate, for example, IP packets, Frame Relay frames, Asynchronous Transfer Mode (ATM) cells, voice, video, data, and other suitable information between network addresses. Network 108 may include one or more local area networks (LANs), radio access networks (RANs), metropolitan area networks (MANs), wide area networks (WANs), all or a portion of the global computer network known as the Internet, and/or any other communication system or systems at one or more locations.

Modifications, additions, or omissions may be made to collaborative computing environment 10 without departing from the scope of the present disclosure. The components of collaborative computing environment 10 may be integrated or separated. For example, federated identity manager 14 may be implemented with tools available within virtual world engine 12 or may be implemented as a separate executable process executed on a different computing system. Moreover, the operations of collaborative computing environment 10 may be performed by more, fewer, or other components. For example, a firewall may be implemented between federated identity manager 14 and the other elements of collaborative computing environment 10 to prevent malicious attacks that may compromise its security. Additionally, operations of collaborative computing environment 10 may be performed using any suitable logic comprising software, hardware, and/or other logic. As used in this document, “each” refers to each member of a set or each member of a subset of a set.

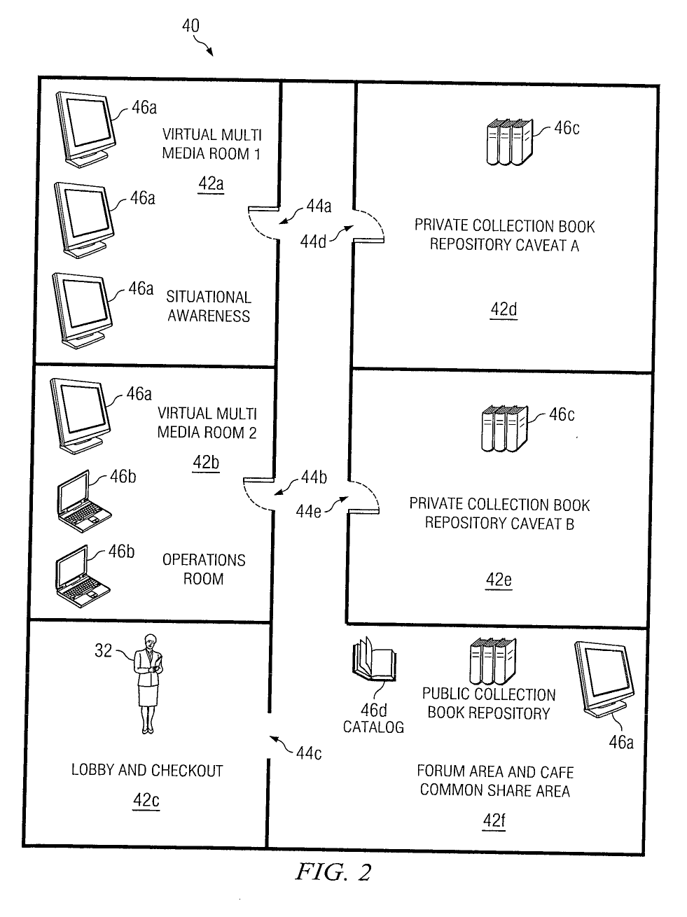

FIG. 2 illustrates an example virtual world environment 40 that may be generated by the multi-level secure collaborative computing environment 10 of FIG. 1 according to certain embodiments of the present disclosure. Virtual world environment 40 includes a number of rooms 42 coupled together through doorways 44. Users may manipulate their associated avatar 32 through the various rooms 42 to access information in collaborative computing environment 10. In some embodiments, users may interact with other users whose avatars 32 are in the same room 42 via a chat session or other similar type of interactive session.

Rooms 42 may provide access to information stored in data repositories 24 according to a specified security level. For example, room 42a may provide access to information in data repositories 24 having a confidential security level, while room 42b may provide access to information having a secret security level. The rooms 42 which a user's avatar 32 may access may be determined according to a security level stored in the user's avatar 32. For example, a particular user may have an account that is established at a top secret security level. Thus, this particular user may access top secret information by moving his or her associated avatar 32 into rooms 42 having a top secret security level. In some embodiments, users may access information at or below his or her security level by moving his or her associated avatar 32 into rooms 42 having a security level at or below a security level associated with the avatar 32.

As described above, avatar 32 may include various forms of information associated with its particular user. In some embodiments, avatar 32 includes one or more biometric signatures, profile information, and/or other type of authentication information, such as described above, that may be used by federated identity manager 14 to uniquely authenticate a user through its associated avatar 32. Avatar 32 may include a clearance level of its associated user.

Additionally or alternatively, avatar 32 may include information associated with one or more roles of the associated user. For example, the one or more roles may include a data miner, a general participant, an administrator, a coordinator, an observer, a communication intelligence guard, and the like. The one or more roles may be used by federated identity manager 14 to track the location of avatar 32 within virtual world environment 40 for generation of auditable actions within collaborative computing environment 10. For example, federated identity manager 14 may track the location of avatar 32 over a period of time and compare the security level of information accessed by avatar 32 to the one or more roles of avatar 32. In this manner, federated identity manager 14 may ascertain whether the user associated with avatar 32 has been accessing information in collaborative computing environment 10 that may be outside the scope of his or her one or more assigned roles.

Virtual world environment 40 may include icons 46 indicating a particular type of information that may be provided in particular rooms 42. For example, icons 46a resemble computer terminals and may represent an access point for information conforming to a publish/subscribe model such as an RDF site summary (RSS) feed. As another example, icons 46b resemble laptop computers and may represent an interactive session with one or more specific data repositories 24. As another example, icons 46c resemble book repositories and may represent access points for documentation stored in data repositories 24. As another example, icon 46d resembles a book and may represents a catalog that includes structured metadata associated with other information stored in data repositories 24.

Room 42c may be referred to as a lobby. Avatars 32 of collaborative computing environment 10 may be placed initially in room 46c at the start of a login session. In the illustrated example, doorway 44c has no closeable door indicating that movement to room 42f may be possible by a user's avatar 32 without any special security level. Conversely, doorways 44b, 44c, 44d, and 44e are closeable indicating that a certain security level is required for the user's avatar 32 to enter its corresponding room 42b, 42c, 42d, and 42e, respectively. In some embodiments, doorways 44b, 44c, 44d, and 44e represent high assurance guards 28 that restrict movement across boundaries according to a specified security level. Rooms 42d and 42e provide access to information that may include sensitive compartmented information referred to as caveats (caveat A and caveat B, respectively). Thus, user's avatars 32 having access rights to room 42d may not necessarily have access to room 42e and vice-versa.

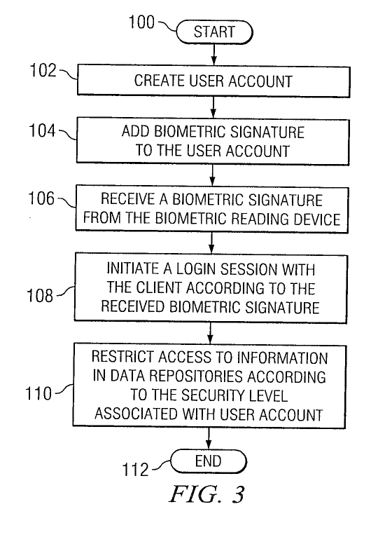

FIG. 3 illustrates an example series of actions that may be performed by the multi-level secure collaborative computing environment 10 of FIG. 1 according to certain embodiments of the present disclosure. For example, the series of actions may be performed by multi-level secure collaborative computing environment 10 to manage access to information stored in data repositories 24 by clients 18. In act 100, the process is initiated.

In act 102, federated identity manager 14 may create a user account by generating an avatar 32 in account storage device 30. The generated avatar 32 may include various credentials associated with the user, including one or more assigned security clearances, or other user profile information. In some embodiments, federated identity manager 14 creates the user account in response to a request from a user of client 18.

In act 104, federated identity manager 14 may add one or more biometric signatures to the generated avatar 32. Biometric signatures may include retina, fingerprint, palm, or facial information that uniquely identifies the user of the user account. In some embodiments, the biometric signature may be a graphic file representing the biometric signature of the user. Additionally or alternatively, biometric signatures may have any form that uniquely represents its respective user compared to other users. At this point, the user account for the user has been established in which access to information in collaborative computing environment 10 may be provided through a login session using the generated avatar 32.

In act 106, federated identity manager 14 may receive a biometric signature from a client 18 coupled to collaborative computing environment 10. In some embodiments, federated identity manager 14 may also include other information associated with the user such as user profile information, including a username, a password, or other uniquely identifiable information associated with the user.

In act 108, federated identity manager 14 initiates a login session with the client 18. Federated identity manager 14 compares the received biometric signature and other user profile information with information stored in the avatar 32. If a proper match is not made the login session is not generated. If a proper match, however, is made between the stored and received biometric signature, the login session is initiated and a virtual world environment 40 may displayed on client 18 with the user's avatar 32.

In act 110, the user's avatar 32 may be restricted to movement through virtual world environment 40 according to the security level associated with his or her security level. In some embodiments, federated identity manager 14 may periodically receive the location of avatar 32 and record the received location with the avatar's identity in a logfile. In this manner, federated identity manager 14 may monitor users of collaborative computing environment 10 over a period of time to identify potentially malicious users who may attempt or otherwise obtain entry into unauthorized rooms 42.

The user of collaborative computing environment 10 may continue accessing information in data repositories 24 according to the security level associated with avatar 32 throughout the duration of his or her login session. In act 112, the login session is canceled or otherwise terminated and the process ends.

Modifications, additions, or omissions may be made to the above-described series of actions without departing from the scope of the present disclosure. The series of actions may include more, fewer, or other acts. For example, federated identity manager 14 may periodically audit the logfile of each or several avatars 32 it maintains to determine any abnormal behavior that may indicate malicious use of collaborative computing environment 10. Moreover, certain of the acts described with reference to FIG. 3 may take place substantially simultaneously and/or in different orders than as shown and described.

Certain embodiments of the present disclosure may provide one or more technical advantages. For example, certain embodiments of the collaborative computing environment 10 may provide enhanced security for compartmented computing systems operating in a virtual world environment 40. Virtual world environments 40 may provide relatively more efficient use due to their ergonomic look-and-feel. Conventional implementations of virtual world engines that drive virtual world environments, however, may not natively include adequate security measures to be used with compartmented computing systems that are administered with a relatively high degree of security. The collaborative computing system 10 according to certain embodiments of the present disclosure may provide a solution to this problem by implementing biometric reading devices with each client 18 that accesses information to enhance security associated with each user.

Although the present disclosure has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims.

What is claimed is:

1. A collaborative computing environment, comprising:
a federated identity manager coupled to a client comprising a biometric reading device and to a multi-level secure computing network comprising a plurality of data repositories coupled together in a federated network, the plurality of data repositories storing information according to a ranked classification system comprising a plurality of security levels, the federated identity manager comprising a storage device operable to store a plurality of identity tokens each associated with a corresponding one of a plurality of users, the federated identity manager operable to:
receive, from the biometric reading device, a biometric signature associated with a particular one of the plurality of users;
initiate a login session with the client according to the biometric signature associated with the particular user; and
restrict access to the information stored in the plurality of data repositories according to one or more security levels associated with the particular user as specified by the identity token associated with the particular user.

2. The collaborative computing environment of claim 1, further comprising a virtual world engine coupled to the multi-level secure computing network and the federated identity manager, the virtual world engine operable to display a virtual world environment comprising a plurality of access points associated with the plurality of data repositories.

3. The collaborative computing environment of claim 2, wherein the plurality of identity tokens comprise a plurality of avatars.

4. The collaborative computing environment of claim 2, wherein the federated identity manager is operable to:
receive, periodically, a location in the virtual world environment of the identity token associated with the particular user; and
store the identity token and the location of the identity token in a logfile.

5. The collaborative computing environment of claim 2, wherein the virtual world environment comprises a plurality of rooms that each has at least one of the plurality of access points, each of the plurality of rooms having a door corresponding to a high assurance guard coupled to one of the plurality of data repositories.

6. The collaborative computing environment of claim 1, wherein the biometric reading device comprises one or more of the following:
a retina/eye scanner;
a palm reader;
a fingerprint reader; and
a facial recognition device.

7. The collaborative computing environment of claim 1, wherein the federated identity manager is operable to:
receive from the client user profile information associated with the particular user; and
create the login session according to the received user profile information.

8. The collaborative computing environment of claim 7, wherein the user profile information comprises one or more of the following:
a username;
a password; and
a personal identifiable piece of information.

9. A computer-implemented method, comprising:
receiving a biometric signature associated with a particular one of a plurality of users from a biometric reading device of a client, the client coupled to a multi-level secure computing network comprising a plurality of data repositories coupled together in a federated network, the plurality of data repositories storing information according to a ranked classification system comprising a plurality of security levels;
initiating a login session with the client according to the received biometric signature associated with the particular user; and
restricting access to the information stored in the plurality of data repositories according to one or more security levels associated with the particular user as specified by an identity token associated with the particular user.

10. The computer-implemented method of claim 9, further comprising:
displaying a virtual world environment comprising a plurality of access points that are associated with the plurality of data repositories; and
accessing the information stored in the plurality of data repositories through the plurality of access points.

11. The computer-implemented method of claim 10, wherein the identity token associated with the particular user comprises an avatar.

12. The computer-implemented method of claim 10, further comprising:
receiving a location in the virtual world environment of the identity token associated with the particular user; and
storing the identity token and the location of the identity token in a logfile.

13. The computer-implemented method of claim 10, wherein displaying the virtual world environment comprises displaying the virtual world environment comprising a plurality of rooms that each has at least one of the plurality of access points, each of the plurality of rooms having a door corresponding to a high assurance guard coupled to one of the plurality of data repositories.

14. The computer-implemented method of claim 9, wherein the biometric reading device comprises one or more of the following:
a retina/eye scanner;
a palm reader;
a fingerprint reader; and
a facial recognition device.

15. The computer-implemented method of claim 9, further comprising:
receiving, from the client, user profile information associated with the particular user; and
creating the login session according to the received user profile information.

16. The computer-implemented method of claim 15, wherein the user profile information comprises one or more of the following:
a username;
a password; and
a personal identifiable piece of information.

17. Code implemented on a computer-readable medium and when executed by a computer, operable to perform operations comprising:
receiving a biometric signature associated with a particular one of a plurality of users from a biometric reading device of a client, the client coupled to a multi-level secure computing network comprising a plurality of data repositories coupled together in a federated network, the plurality of data repositories storing information according to a ranked classification system comprising a plurality of security levels;
initiating a login session with the client according to the received biometric signature associated with the particular user; and
restricting access to the information stored in the plurality of data repositories according to one or more security levels associated with the particular user as specified by an identity token associated with the particular user.

18. The code of claim 17, wherein the code is further operable to:
display a virtual world environment comprising a plurality of access points that are associated with the plurality of data repositories; and
access the information stored in the plurality of data repositories through the plurality of access points.

19. The code of claim 18, wherein the identity token associated with the particular user comprises an avatar.

20. The code of claim 18, wherein the code is further operable to:
receive a location in the virtual world environment of the identity token associated with the particular user; and
store the identity token and the location of the identity token in a logfile.

21. The code of claim 18, wherein displaying the virtual world environment comprises displaying the virtual world environment comprising a plurality of rooms having at least one of the plurality of access points, each of the plurality of rooms having a door corresponding to a high assurance guard coupled to one of the plurality of data repositories.

22. The code of claim 17, wherein the biometric reading device of the client comprises one or more of the following:
a retina/eye scanner;
a palm reader;
a fingerprint reader; and
a facial recognition device.

23. The code of claim 17, wherein the code is further operable to:
receive, from the client, user profile information associated with the particular user; and
create the login session according to the received user profile information.

24. The code of claim 23, wherein the user profile information comprises one or more of the following:
a username;
a password; and
a personal identifiable piece of information.
